(19) United States
(12) Patent Application Publication
(10) Pub. No.: US 2018/0135331 A1
(43) Pub. Date: May 17, 2018

(54) T-POST REMOVAL APPARATUS

(71) Applicant: 3-C Contracting LLC

(72) Inventor: Darren Couch, Bells, TX (US)

(73) Assignee: 3-C Contracting LLC, Bells, TX (US)

(21) Appl. No.: 15/350,310

(22) Filed: Nov. 14, 2016

(51) Int. Cl. E04H 17/26; B66F 19/00; B66C 1/64

(52) U.S. Cl. CPC E04H 17/265; B66F 2700/09; B66C 1/64; B66F 19/00

(57) ABSTRACT

An apparatus for removing T-posts being a plate having a generally rectangular shape measuring 10 inches lengthwise and 4 inches widthwise, the plate having a bend measuring 130 degrees bisecting proximate the center of the plate width-wise forming a first, generally square section and a second, generally square section. The invention has a triangular cutout through the plate centered in the first section, the apex of the triangular cutout pointing toward the bend and a base and legs measuring 2.75 inches; and a circular cutout through the plate measuring 2 inches in diameter centered in the second section.

### CROSS REFERENCE TO RELATED APPLICATION

Not Applicable.

### FIELD OF THE INVENTION

The present invention relates to an apparatus for removing fence posts and T-posts.

### BACKGROUND

A steel fence post, also referred to as a T-post, a Y-post, or variants on a star post, is a type of fence post or picket. These posts are collectively referred herein as a T-post. The T-post is made of steel, often manufactured using durable rail steel. They can be used to support various types of wire or wire mesh. The end view of the post is an T, Y or other shape. The posts are driven into the ground with a manual or pneumatic post pounder. All along the post, along the spine, there are studs or nubs that prevent the barbed wire or mesh from sliding up or down the post. They are generally designated as 1.01, 1.25 or 1.33, referring to the weight in pounds per lineal foot. T-Posts are commonly sold in the United States and Y-posts are sold elsewhere. Often, these T-posts are used to temporarily confine areas and are often removed and reused.

Conventional T-post lifters or removers are adapted to remove fence posts. Such conventional lifters are heavy, expensive, complex devices with, inter alia, a steel handle and jack mechanism to provide the leverage necessary to lift posts. Disadvantageously, such jack based T-post removers tend to bend or crimp such T-posts and are expensive. What is desired is a simple, non-complex apparatus designed to remove a T-post without bending or crimping the T-post.

### SUMMARY

Although the invention is described as being configured to receive and remove a T-post, the apparatus can be configured to receive and remove similar types of posts. All such embodiments and arrangements are claimed by, and considered within the scope of this invention.

### THE DRAWINGS

Other features of the invention will become clear from the following description, taken together with the accompanying drawings wherein

FIG. 1 is a perspective view of the invention;

FIG. 2 is a side perspective view of the invention

FIG. 3 is a side elevational view of the invention; and

FIG. 4 is a top plan view of the invention.

### DESCRIPTION OF THE INVENTION

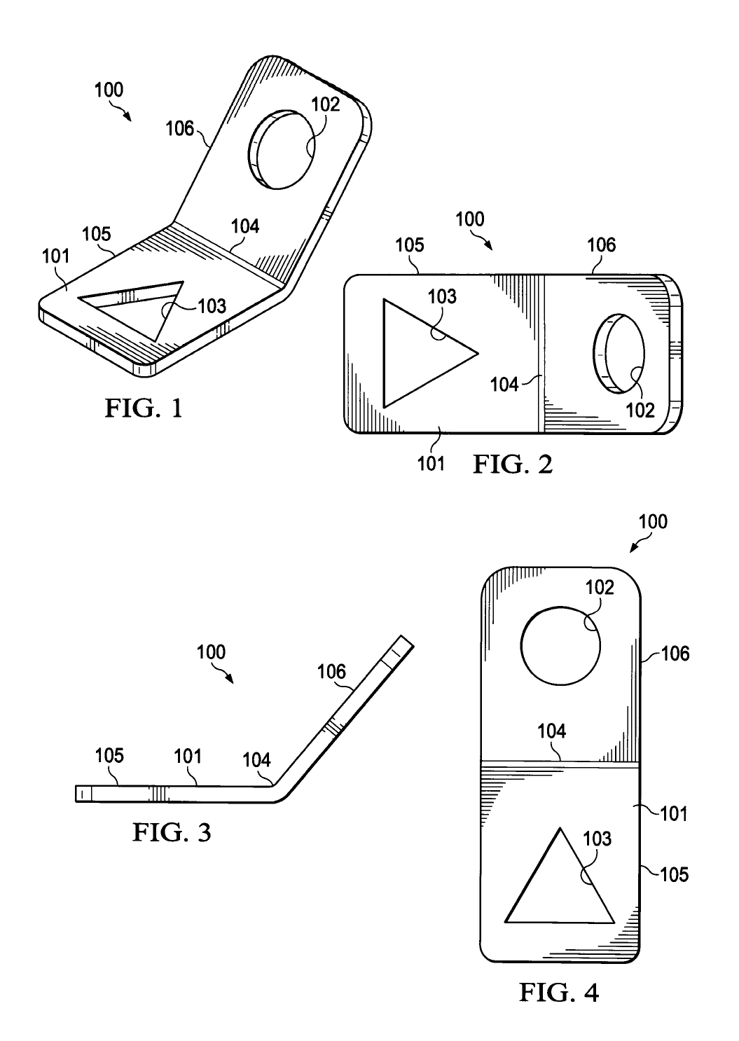

Referring to FIGS. 1, 2, 3 and 4, the invention comprises an apparatus 100 for removing T-posts, comprising a plate 101 having a generally rectangular shape, the plate having a bend 104 bisecting proximate the center of the plate widthwise forming a first, generally square section 105 and a second, generally square section 106. The plate has a triangular cutout 103 through the plate centered in the first section 105, the apex of the triangular cutout pointing toward the bend and a circular cutout 102 through the plate centered in the second section 106.

In an embodiment, the bend 104 forms an angle of between 120 degrees and 145 degrees, in a preferred embodiment the bend 104 forms a 130 degree angle. The plate 100 is fabricated of steel or other resilient material. For example the plate 100 can comprise ASTM A36 plate. The plate 100 is between ¼ inch and 1 inch in thickness. In an embodiment, the plate 100 is ½ inch in thickness. The plate 100 can be dimensioned 8 inches to 12 inches in length and 3 to 5 inches in width. In a preferred embodiment, the plate 100 is dimensioned 10 inches length and 4 inches width. In an embodiment, the circular cutout 102 has a diameter of between 1 inch and 3 inches in diameter. In a preferred embodiment, the circular cutout 102 has a diameter of 2 inches. In an embodiment, the triangular cutout 103 has a base measuring between 2 inches and 3.5 inches and legs having the same length of the base. In a preferred embodiment, the triangular cutout 103 has a base and legs measuring 2.75 inches in length.

The invention having a plate 100 having a generally rectangular shape measuring 10 inches length-wise and 4 inches width-wise, the plate 100 having a bend 104 measuring 130 degrees bisecting proximate the center of the plate 100 width-wise forming a first, generally square section 105 and a second, generally square section 106. There is a triangular cutout 103 through the plate 100 centered in the first section 105, the apex of the triangular cutout 103 pointing toward the bend 104, the triangle cutout 103 having a base and legs measuring 2.75 inches; and a circular cutout 102 through the plate 101 measuring 2 inches in diameter centered in the second section 106.

The base of the triangle cutout 103 is positioned 1 inch from the right width-wise edge of the first section 105 and the vertex thereof is positioned 2 inches from the top and bottom length-wise edges and the center of the circular cutout 102 is positioned 2 inches from the left width-wise edge and the top and bottom length-wise edges of the second section 106. The plate 101 comprises ASTM A36 plate between ¼ inch and 1 inch in thickness. ASTM A36 plate is a low carbon steel that exhibits good strength coupled with formability that can be galvanized to provide increased corrosion resistance.

A preferred embodiment of the apparatus for removing a T-post that has been pounded into the ground is used as follows: A hook on one end of a chain, cable or other means for transferring force is placed through or inserted into the circular cutout 102. The other end of the chain, cable or other means for providing upward force is coupled to a machine to provide upward force, such as tractor boom, bucket, loader or jack. The triangle cutout 103 is then lowered over a T-post. As the boom, bucket, loader or jack is moved upward, the triangle cutout 103 catches the T-post and retains it using a frictional force. Upward force is transferred through the chain, cable or other means to the plate and operates to pull the invention, and hence the T-post up and out of the ground without bending the T-post. Because the invention has not been permanently or semi-permanently coupled to the T-post, it will release the T-post after it has been removed from the ground, allowing the user to quickly move to the next T-post to be removed.

While the present invention has been described by reference to certain embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. An apparatus for removing T-posts, comprising:
a plate having a generally rectangular shape, the plate having a bend bisecting proximate the center of the plate widthwise forming a first, generally square section and a second, generally square section;
a triangular cutout through the plate centered in the first section, the apex of the triangular cutout pointing toward the bend; and
a circular cutout through the plate centered in the second section.

2. The apparatus of claim 1, wherein the bend forms an angle of between 120 degrees and 145 degrees.

3. The apparatus of claim 2, wherein the bend forms a 130 degree angle.

4. The apparatus of claim 1, wherein the plate comprises ASTM A36 plate.

5. The apparatus of claim 4, wherein the plate is between ¼ inch and 1 inch in thickness.

6. The apparatus of claim 5, wherein the plate is % inch in thickness.

7. The apparatus of claim 1, wherein the plate is dimensioned 8 inches to 12 inches in length and 3 to 5 inches in width.

8. The apparatus of claim 7, wherein the plate is dimensioned 10 inches length and 4 inches width.

9. The apparatus of claim 1 wherein the circular cutout has a diameter of between 1 inch and 3 inches in diameter.

10. The apparatus of claim 9, wherein the circular cutout has a diameter of 2 inches.

11. The apparatus of claim 1, wherein the triangular cutout has a base measuring between 2 inches and 3.5 inches and legs having the same length of the base.

12. The apparatus of claim 1, wherein the triangular cutout has a base and legs measuring 2.75 inches.

13. An apparatus for removing T-posts, comprising:
a plate having a generally rectangular shape measuring 10 inches lengthwise and 4 inches widthwise, the plate having a bend measuring 130 degrees bisecting proximate the center of the plate width-wise forming a first, generally square section and a second, generally square section;
a triangular cutout through the plate centered in the first section, the apex of the triangular cutout pointing toward the bend, the triangle having a base and legs measuring 2.75 inches; and
a circular cutout through the plate measuring 2 inches in diameter centered in the second section.

14. The apparatus of claim 13, wherein the base of the triangle is positioned 1 inch from the right width-wise edge of the first section and the vertex thereof is positioned 2 inches from the top and bottom length-wise edges and the center of the circular cutout is positioned 2 inches from the left width-wise edge and the top and bottom length-wise edges.

15. The apparatus of claim 13, wherein the plate comprises ASTM A36 plate.

16. The apparatus of claim 15, wherein the plate is between ¼ inch and 1 inch in thickness.

17. The apparatus of claim 16, wherein the plate is % inch in thickness.
